(19) United States
(12) Patent Application Publication
(10) Pub. No.: US 2009/0050680 A1
(43) Pub. Date: Feb. 26, 2009

(54) Method for connecting tubular solid oxide fuel cells and interconnects for same

(75) Inventors: Christine Martin, Superior, CO (US); Jerry L. Martin, Superior, CO (US)

Correspondence Address: EDWARDS ANGELL PALMER & DODGE LLP, P.O. BOX 55874, BOSTON, MA, 02205, US

(73) Assignee: Protonex Technology Corporation, Southborough, MA (US)

(21) Appl. No.: 11/895,333

(22) Filed: Aug. 24, 2007

(51) Int. Cl. B23K 1/00; B23K 31/00

(52) U.S. Cl. 228/262.9; 228/262.1; 429/31

(57) ABSTRACT

An interconnect for electrically connecting a first and second cell of a tubular fuel cell bundle having a body with an anode contact and a cathode contact extending therefrom. The anode contact is formed to follow a contour of an anode portion of the first cell. The cathode contact is formed to follow a contour of a cathode portion of the second cell. A contact aid may be applied to the anode contact and/or cathode contact for securing the contact to the respective portion of the fuel cell bundle. The interconnect preferably completes a series connection between the first and second cells.

### BACKGROUND OF THE INVENTION

1. Field of the Invention

The subject disclosure relates to fuel cells, and more particularly to a solid oxide fuel cell (SOFC) having an improved interconnection between cells in a cell assembly.

2. Background of the Related Art

Fuel cells are used to generate power by an electrochemistry process that uses readily available fuel (e.g., air and hydrogen) and produces electricity and heat with clean byproducts (e.g., water). It is expected that fuel cells will power everything from cell phones to automobiles as well as generate power for consumption by devices in the home and workplace. As a result, much effort has been and will continue to be put forth towards perfecting fuel cell design, manufacture and the associated infrastructure.

Some examples of the evolving technology are U.S. Patent Application Nos. 2004/0058203 A1 to Priestnall et al., 2003/0165727 A1 to Priestnall et al. and 2006/0078782 to Martin et al. One very promising type of fuel cell is the solid oxide fuel cell (SOFC). Some examples are illustrated in U.S. Pat. Nos. 6,749,799 issued on Jun. 15, 2004 to Crumm et al., U.S. Pat. No. 6,998,187 issued on Feb. 14, 2006 to Finnerty et al., U.S. Pat. No. 6,776,956 issued on Aug. 17, 2004 to Uehara et al., U.S. Pat. No. 6,794,078 issued on Sep. 21, 2004 to Tashiro et al., and U.S. Pat. No. 6,770,395 B2 issued on Aug. 3, 2004 to Virkar et al. The components that generate power are commonly referred to as cells. As the voltage for an individual cell may be relatively low, it is often necessary to operate the cells in series in order to generate practical voltage levels. This assembly of cells is also referred to as a “stack” or “bundle”.

For cells to be connected in series, connections must be made from the anode of one cell to the cathode of an adjacent cell. In a solid oxide fuel cell stack, these connections are exposed to a high temperature oxidizing or reducing environment. In prior art tubular cells, the connections between the tubes have been made using ceramic or metal connectors which are exposed to the oxidizing environment such as shown in U.S. Patent App. No. 02005/0147857A1 to Crumm et al. (the '857 application). The '857 application discloses the use of a wire wrapped around one tube and connected to the anode and extending to the cathode of an adjacent tube. Wire connections such as these are time-consuming to apply and require expensive materials to provide the necessary electrical conductivity and oxidation resistance.

### SUMMARY OF THE INVENTION

There is a need for an improved cell interconnect which ensures good electrical contact, robust mechanical connection, easy installation, easy assembly and low cost as well as a method for using the same. Additionally, a desirable interconnect would reduce the number of overall parts and minimize the number of joints or connections required.

In one embodiment, the present disclosure is directed to an interconnect for electrically connecting a first and second cell of a tubular fuel cell bundle having a body with an anode contact and a cathode contact extending therefrom. The anode contact is pre-formed to follow a contour of an anode portion of the first cell and the cathode contact is pre-formed to follow a contour of a cathode portion of the second cell. A contact aid may be applied to the anode contact and/or cathode contact for securing the contact to the respective portion of the fuel cell bundle. The interconnect preferably completes a series connection between the first and second cells.

The present disclosure is also directed to a interconnect for electrically connecting a first and second cell of a fuel cell. The interconnect includes a body, an anode contact extending from the body and formed to follow a contour of an anode portion of the first cell, a first contact aid on the anode contact for securing the anode contact to the anode portion, a cathode contact extending from the central body and formed to follow a contour of a cathode portion of the second cell and a second contact aid on the cathode contact for securing the cathode contact to the cathode portion and, in turn, complete a series connection between the first and second cells. Preferably, the body, anode contact and cathode contact are made from material selected from the group consisting of nickel, silver, copper and combinations thereof. In a further embodiment, the body has a step from which the cathode contact extends. In still another embodiment, the anode portion includes an anode and a sleeve disposed against the anode and extending from the anode for coupling to the anode contact.

Still another embodiment of the present disclosure is directed to an interconnect for electrically connecting a first and second cell of a fuel cell bundle. The interconnect includes a body, an anode contact extending from the body and formed to follow a contour of an anode of the first cell and a cathode contact extending from the body and formed to follow a contour of an cathode of the second cell, wherein the body, the anode contact and the cathode contact are configured and arranged to create a retentive force and complete a series connection when the interconnect is disposed between the first and second cells.

The present disclosure is also directed to a method for electrically coupling a first and a second cell of a fuel cell bundle, each cell being tubular and including an anode on an inner surface and a cathode on an outer surface. The method includes the steps of preforming an interconnect having a body, a cathode contact extending from the body and an anode contact extending from the body, coating the cathode and anode contacts with a contact aid and disposing the interconnect between the cells such that the cathode contact is secured to the cathode and the anode contact is secured to the anode.

An alternate method includes the steps of preforming an interconnect having a body, a cathode contact extending from the body and an anode contact extending from the body, coating the cathode and anode with a contact aid such as a braze and disposing the interconnect between the cells such that the cathode contact is brazed to the cathode and the anode contact is brazed to the anode.

It should be appreciated that the present invention can be implemented and utilized in numerous ways, including without limitation as a process, an apparatus, a system, a device, and a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a top perspective view of a fuel cell assembly having preformed interconnects to electrically connect a plurality of SOFC cells in accordance with the subject technology.

FIG. 1A is a partial cross-sectional view of one of the interconnects of FIG. 5 disposed on adjacent cells.

FIG. 2 is a perspective view of one of the interconnects of FIG. 1.

FIG. 3 is a partial top perspective view of another fuel cell assembly with preformed interconnects to electrically connect a plurality of SOFC cells in accordance with the subject technology.

FIG. 4 is a perspective view of one of the interconnects of FIG. 3.

FIG. 5 is a partial top perspective view of still another fuel cell assembly with interconnects to electrically connect a plurality of SOFC cells in accordance with the subject technology.

FIG. 6 is an isolated top perspective view of a single interconnect on adjacent cells in the fuel cell assembly of FIG. 5.

FIG. 7 is a partial cross-sectional view of one of the interconnects of FIG. 5 disposed on adjacent cells.

FIG. 8 is a perspective view of one of the interconnects of FIG. 5.

FIG. 9 is a reverse perspective view of one of the interconnects of FIG. 5.

### DETAILED DESCRIPTION OF PREFERRED EMBODIMENTS

The present invention overcomes many of the prior art problems associated with interconnects for fuel cells. The advantages, and other features of the interconnects, systems using the interconnects and methods disclosed herein, will become more readily apparent to those having ordinary skill in the art from the following detailed description of certain preferred embodiments taken in conjunction with the drawings which set forth representative embodiments. All relative descriptions herein such as upward, downward, top, bottom, left, right, up, and down are with reference to the Figures, and not meant in a limiting sense. Additionally, for clarity, common items such as conduits, housings and the like have not been included in the Figures as would be appreciated by those of ordinary skill in the pertinent art.

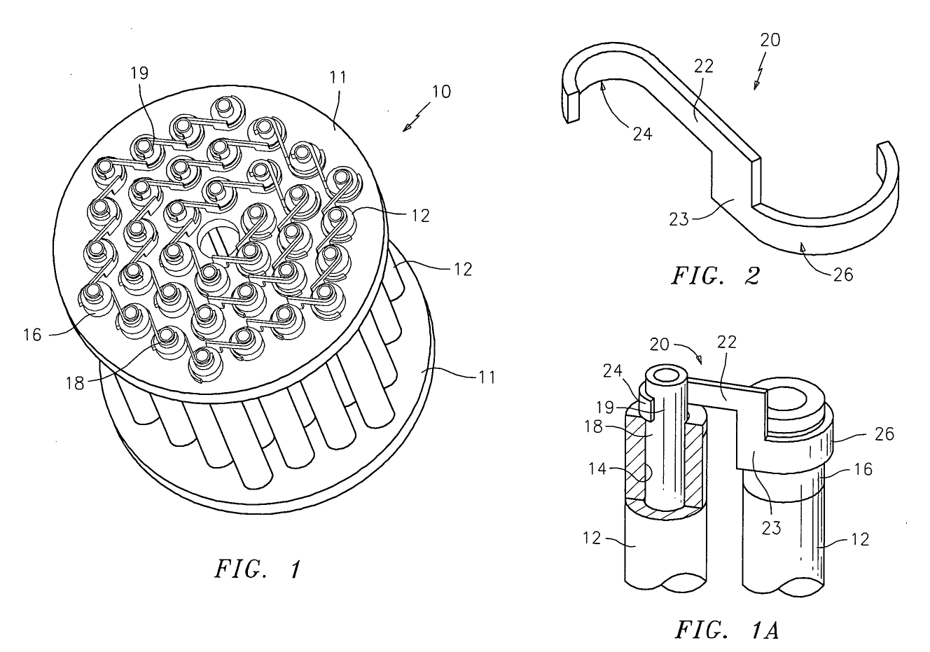

Referring to FIG. 1, a top perspective view of a solid oxide fuel cell (SOFC) stack assembly is shown and referred to generally by the reference numeral 10. The stack assembly 10 produces power by an electrochemical process such as that described in the patents and patent applications noted herein. The stack assembly 10 has a plurality of tubular cells or tubes 12. The cells 12 include an anode 14 on an inner surface (see FIG. 1A) and a cathode 16 on the outer surface. For simplicity, not all of the cells 12 are provided with reference numerals. When reactants pass over the cells 12, electricity, heat and water are generated. Typically, the reactants are oxygen or air passing over the cathode 16 and hydrogen, carbon monoxide, methane, steam or mixtures of these gases passing over the anode 14. It is also envisioned that an electrolyte or other interlayers may be located intermediate to the anodes 14 and cathodes 16. The cells 12 are connected in series by a plurality of interconnects 20.

Referring to FIG. 1A, a partial cross-sectional view of one of the interconnects disposed on adjacent cells is shown. In each cell 12, an extension tube or metal sleeve 18 nests within the anode 14 and extends upward above the cell 12. The outer surface of the tube 18 is in electrical contact with and secured to the anode 14 except for a small portion 19, which extends upward. The tube 18 may be brazed, with or without a coating, soldered, crimped or otherwise fixed in place. To complete the series electrical connection between the cells 12, the interconnect 20 extends between the small portion 19 extending above the anode 14 to the cathode 16.

The braze, coating and/or means of fixing also preferably improves the electrical contact between mating parts. Such contact aids may be a braze, a solder, a conductive paste or a conductive powder that sinters its particles together. One or more contact aids may be applied to the tube 18, the interconnects 20 or both, in whole or in part. Such contact aids may be on one end, on both ends, applied to the tube 18, applied to the interconnects 20, or applied to both. The contact aids may vary from location to location and/or from component to component. It is hereby taught that no contact aid may be necessary as the interconnects 20 can function efficiently without one.

Referring now to FIG. 2, a perspective view of an interconnect 20 is shown. The interconnect 20 is particularly suited for electrically connecting two cells 12. The interconnect 20 has a body 22 that is substantially a rectangular plate. An anode contact 24 and cathode contact 26 extend from opposite ends of the body 22. The body 22 also includes a step 23 from which the cathode contact 26 extends. The step 23 adjusts the relationship between the contacts 24, 26 so that the interconnect 20 makes proper contact between the tube 19 (effectively the anode 14) and the cathode 16 as shown in FIG. 1.

Each contact 24, 26 is formed to follow a contour of the tubes 19 and cathodes 16, respectively. Each contact 24, 26 is arcuate or semi-circle shaped in order to provide high surface area against the tubes 19 and cathodes 16. The interconnects 20 are preformed so that the shapes are consistent and improved contact results. By preforming, manufacturing cost is reduced, assembly is simplified and a wider array of materials can be used. For example, strict manufacturing tolerances in the cell assembly 10 are lessened.

In one embodiment, the interconnect 20 is sized and shaped to create a retentive force and complete a series connection when inserted between two cells 12. For example, the body 22 has some resiliency so that the anode contact 24 and cathode contact 26 must be urged apart for placement in a tight fitting manner between the tube 19 of one cell 12 and the cathode 16 of a nearby cell 12. Upon placement, the contacts 24, 26 would maintain tension between the cells 12 to create the retentive force. The interconnects 20 are preformed from sheet stock and preferably have some flexibility so that the dimensions can quickly, easily and permanently be fine tuned for proper fit during assembly.

It is noted that the contacts 24, 26 are not limited to the opposing semi-circles shown and that any arrangement complimentary to the shape of the anodes 14, cathodes 16 or tubes 19 is well within the scope of this disclosure. Although the anode contact 24 and the cathode contact 26 may create a retentive force between the tube 19 and corresponding cell 12 by urging these parts together, such action is not required. In another embodiment, the contacts 14, 16 could be arranged to create a retentive force upon the interconnect by urging these parts away from each other.

The contacts 24, 26 may be coated with a braze to enhance the robustness of the electrical connection and ease of installation. The braze ensures an effective bond between the interconnect 20 and cells 12 even during harsh thermal cycling. The braze also helps create low electrical resistance joints to minimize electrical losses. The braze is just one exemplary type of contact aid.

Using the interconnects disclosed here, it is possible to connect groups of cells electrically either in series, in parallel or combinations of series and parallel. Combinations of series and parallel connections are preferred for many applications in order to achieve the proper combination of stack voltage and current. For series connections, all the cells in the bundle are connected in a single series using the interconnects. In a series-parallel arrangement, a group of two or more cells are connected in series using the interconnects, and then these groups are connected in parallel. For example, a bundle of 36 cells could be divided into three groups of 12 cells in series, and then these three groups could be connected in parallel to yield a bundle that produces higher current at lower voltage than a series arrangement. The connections between the groups can be made inside the bundle using wires, conductive pastes, brazes or interconnects as disclosed here. In an alternative embodiment, the two terminal connections from each group of series cells may be brought out of the bundle and the parallel connections between the series groups made outside the bundle.

During assembly, each interconnect 20 is disposed to electrically couple adjacent cells 12. As best seen in FIG. 1, almost every cell 12 has an anode contact 24 and a cathode contact 26 coupled thereto. Initially, the interconnects 20 are placed between adjacent cells 12. As noted above, each interconnect 20 may provide a mechanical retentive force when placed between adjacent cells 12. When the interconnects 20 are in position, the braze on each contact 24, 26 is heated, melted or soldered to the respective anode 14 and cathode 16. In alternative embodiments, other means are used for facilitating coupling between the contacts 24, 26 and cells 12 such as, without limitation, a conductive gel, an adhesive, solder, crimping, and combinations thereof

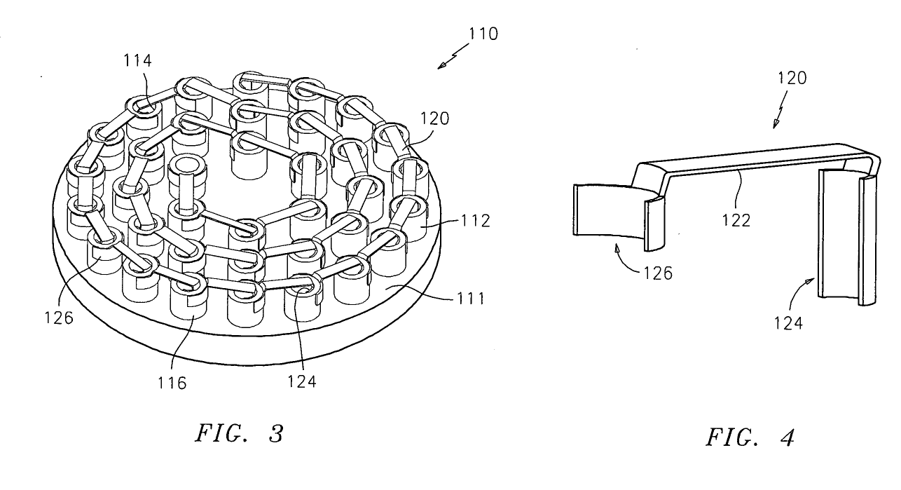

Referring now to FIGS. 3 and 4, a partial top perspective view of another cell assembly 110 and interconnect 120 are shown, respectively. As will be appreciated by those of ordinary skill in the pertinent art, the cell assembly 110 and interconnect 120 utilize similar principles to the cell assembly 10 and interconnect 20 described above. Accordingly, like reference numerals preceded by the numeral “1” are used to indicate similar elements. The primary differences of the embodiment of FIGS. 3 and 4 are the elimination of the need for an extension tube in the cell assembly 110 and complimentary reconfiguration of the interconnect 120. The interconnect 120 is particularly suited for directly connecting two cells 112. The interconnect 120 has a body 122 that is substantially a rectangular plate. An anode contact 124 and cathode contact 126 depend from opposite ends of the body 122. Each contact 124, 126 is formed to follow a contour of the anodes 114 and cathodes 116, respectively. Each contact 124, 126 is an arcuate shaped collar in order to provide high surface area against the anodes 114 and cathodes 116. The anode contact 124 is relatively longer in order to provide ample surface area for electrical contact and extend into the tubular cell 112.

The interconnects 120 are preformed so that the shapes are consistent and improved contact results. Further, manufacturing cost is reduced, assembly is simplified and a wider array of materials can be used. In one embodiment, the body 122, the anode contact 124 and the cathode contact 126 are sized and shaped to create a retentive force and complete a series connection when inserted between two cells 112. For example, the body 112 has some resiliency so that the anode contact 124 and cathode contact 126 can be urged together for insertion in a tight fitting manner between the anode 114 of one cell 112 and the cathode 116 of a nearby cell 112. Upon placement, the contacts 124, 126 would press against the cells 112 to create the retentive force. As can be seen, the interconnects 120 will not require a complicated fixture or tool if anything at all in order to be properly placed.

The contacts 124, 126 may be coated with a braze to enhance the robustness of the electrical connection and ease of installation. The braze ensures an effective bond between the interconnect 120 and cells 112 even during harsh thermal cycling. Further, the braze helps create low electrical resistance joints to minimize electrical losses.

Typical anodes 114 are ceramic or cermet and typical cathodes are cermet or ceramic. Thus, the interconnect 120 should be chosen not to interfere with or poison the anode or cathode. The anode contact 124 and cathode contact 126 may be formed from different material altogether. Materials including, without limitation, nickel, silver, copper and combinations thereof are excellent choices for the interconnect 120 and braze, if any. Nickel is particularly appropriate because of availability in sheet form, which is easily cut, machined and formed into the desired configuration of interconnect. A braze of a silver/copper alloy such as a 72% Ag and 28% Cu alloy is well suited to use on the anode contact 114 and a high temperature silver thick film paste is well suited to use on the cathode contact 116. Many other materials well known to those skilled in the pertinent art based upon review of the subject disclosure would accomplish the desired performance. A silver/copper alloy as described is particularly well suited because of a relatively low melt point which allows assembly without overheating the cells 12 (e.g., melting the silver of a cathode 26).

During assembly, each interconnect 120 is disposed to electrically couple adjacent cells 112. As best seen in FIG. 3, almost every cell 112 has an anode contact 124 and a cathode contact 126 coupled thereto. Initially, the interconnects 120 are placed between adjacent cells 112. As noted above, each interconnect 120 may provide a mechanical retentive force when placed between adjacent cells 112. When the interconnects 120 are in position, the braze on each contact 124, 126 is heated, melted or soldered to the respective anode 114 and cathode 116. In alternative embodiments, other means are used for facilitating coupling between the contacts 124, 126 and cells 112 such as, without limitation, a conductive gel, an adhesive, solder and combinations thereof.

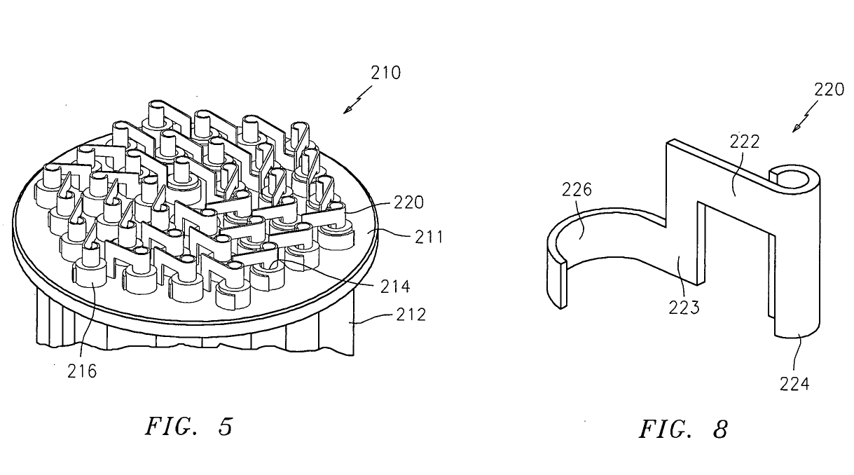

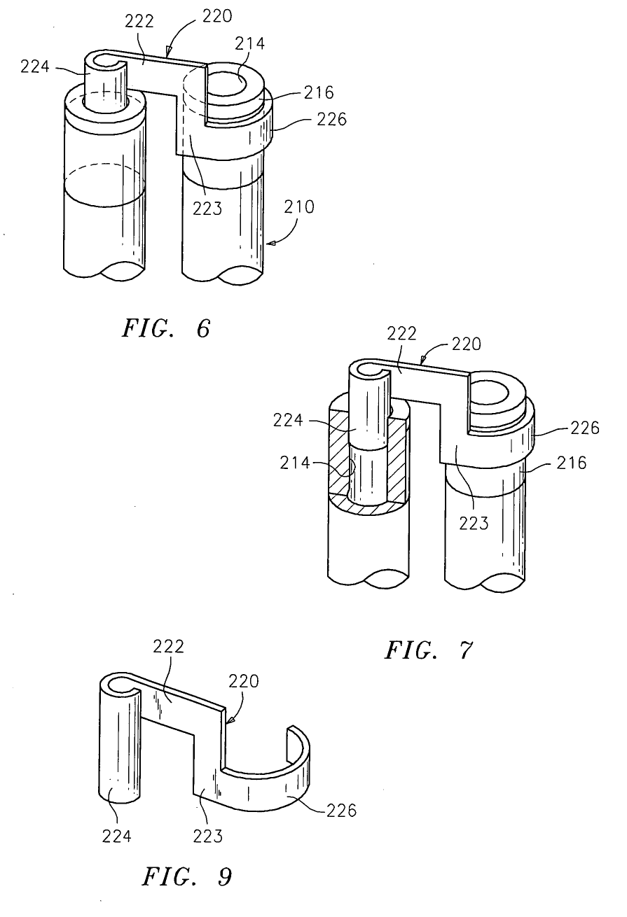

Referring now to FIG. 5, a partial perspective view of still another cell assembly 210 employing an interconnect 220 is shown. As will be appreciated by those of ordinary skill in the pertinent art, the cell assembly 210 and interconnect 220 utilize similar principles to the cell assemblies 10, 110 and interconnects 20, 120 described above. Accordingly, like reference numerals preceded by the numeral “2” are used to indicate similar elements whenever possible and the following description is directed primarily to the differences. To further illustrate the use of the interconnect, FIG. 6 is an isolated view of the interconnect 220 with phantom lines showing the relationship of the anode contact 224 within the anode 14.

Referring to FIG. 7, a partial cross-sectional view of one of the interconnects 220 of FIG. 5 disposed on adjacent cells is shown. The interconnect 220 is particularly suited to couple deeply within the anode 214 and cover a large surface area because of the almost tubular and elongated anode contact 224. Referring to FIGS. 8 and 9, perspective views of the interconnect 220 are shown. The central body 222 has a relatively lengthy anode contact 224 extending from one end. The anode contact 224 is substantially tubular and sized to nest tightly within the tubular cell to contact the anode 214. All or at least a portion of the anode contact 224 may be coated with one or more contact aids.

At the other end, the body 222 includes a step 223 from which a cathode contact 226 extends. The step 223 adjusts the relationship between the contacts 224, 226 so that the interconnect 220 properly clears the cells 212 as shown in FIG. 5. It is noted that the anode contact 224 alone could be sized and configured to create a friction fit to help retain the interconnect in place.

In another embodiment, the anode and/or the cathode has a current collector to help gather current generated by the fuel cell. The current collector is either a metal or high conductivity ceramic layer applied to the anode and cathode as desired. In a small fuel cell, preferably the anode does not have current collector, but the cathode has a porous silver layer for the cathode current collector. In a larger fuel cell, the anode may have a copper wire or mesh for the anode current collector and the cathode may have a silver mesh for the cathode current collector. Other emdodiments are envisioned, without limitation, such as shown in U.S. Patent Application No. 2005/0147857 A1 to Crumm et al. and published on Jul. 7, 2005. It is also envisioned that the anode could surround the cathode. The description above described the cathode on the outside for simplicity but the subject technology is in no way limited to such an arrangement.

### INCORPORATION BY REFERENCE

All patents, published patent applications and other references disclosed herein are hereby expressly incorporated in their entireties by reference.

The illustrated embodiments are understood as providing exemplary features of varying detail of certain embodiments, and therefore, features, components, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and can be altered without materially affecting or limiting the disclosed technology. Accordingly, while the invention has been described with respect to preferred embodiments, those skilled in the art will readily appreciate that various changes and/or modifications can be made to the invention without departing from the spirit or scope of the invention as defined by the appended claims.

What is claimed is:

1. An interconnect for electrically connecting a first and second cell of a tubular fuel cell bundle comprising:
a body;
an anode contact extending from the body and formed to follow a contour of an anode portion of the first cell; and
a cathode contact extending from the central body and formed to follow a contour of a cathode portion of the second cell, such that upon disposing the interconnect on the first and second cells, the interconnect completes a series connection between the first and second cells.

2. An interconnect as recited in claim 1, wherein the body is a substantially rectangular plate.

3. An interconnect as recited in claim 1, wherein the body, anode contact and cathode contact are made from material selected from the group consisting of nickel, silver, copper and combinations thereof.

4. An interconnect as recited in claim 1, wherein the body has a step from which the cathode contact extends.

5. An interconnect as recited in claim 1, wherein the anode and cathode contacts have a semi-circular shape.

6. An interconnect as recited in claim 1, wherein the anode contact and the cathode contact form arcs spaced such that the two cells are urged together to create a retentive force on the interconnect.

7. An interconnect as recited in claim 1, wherein the anode contact and the cathode contact form arcs spaced such that the two cells are urged apart to create a retentive force on the interconnect.

8. An interconnect as recited in claim 1, further including a contact aid for improving the electrical conductance between the interconnect and at least one of the cells.

9. An interconnect as recited in claim 8, wherein the contact aid is selected from a group consisting of braze alloys, braze metals, solders, conductive pastes and combinations thereof.

10. An interconnect as recited in claim 9, wherein the contact aid is a silver/copper alloy or a thick silver film paste.

11. An interconnect as recited in claim 1, wherein the anode portion includes an anode and a sleeve disposed against the anode and extending from the anode for coupling to the anode contact.

12. An interconnect as recited in claim 1, wherein the anode portion includes a current collector that couples to the anode contact.

13. An interconnect as recited in claim 1, wherein the body, the anode contact and the cathode contact are preformed from a sheet of nickel, copper, silver or alloys or combinations thereof.

14. An interconnect as recited in claim 1, wherein the anode contact substantially forms a tubular portion depending from the body.

15. An interconnect as recited in claim 1, wherein the anode portion includes a sleeve disposed against the anode portion and extending from the anode portion for coupling to the anode contact.

16. An interconnect as recited in claim 1, wherein the cathode portion includes a current collector that couples to the cathode contact.

17. An interconnect for electrically connecting a first and second cell of a fuel cell comprising:
a body;
an anode contact extending from the body and formed to follow a contour of an anode of the first cell; and
a cathode contact extending from the central body and formed to follow a contour of an cathode of the second cell,
wherein the body, the anode contact and the cathode contact are configured and arranged to create a retentive force and complete a series connection when the interconnect is disposed between the first and second cells.

18. An interconnect as recited in claim 17, further comprising first means for securing the anode contact to the anode and second means securing the cathode contact to the cathode.

19. An interconnect as recited in claim 17, wherein the first and second means are selected from the group consisting of a braze, a conductive gel, an adhesive, solder, a mechanical crimp, a crimp ring and combinations thereof.

20. A method for electrically coupling a first and a second cell of a fuel cell, each cell being tubular and having an anode and a cathode, the method comprising the steps of:
preforming an interconnect having a body, a cathode contact extending from the body and an anode contact extending from the body;
coating the cathode and anode contacts with a braze;
disposing the interconnect between the cells; and
heating the assembly such that the cathode contact is brazed to the cathode and the anode contact is brazed to the anode.

21. A method for electrically coupling a first and a second cell of a fuel cell, each cell being tubular and having an anode and a cathode, the method comprising the steps of:
preforming an interconnect having a body, a cathode contact extending from the body and an anode contact extending from the body;
coating the cathode and anode contacts with a conductive metal or ceramic coating containing small conductive particles;
disposing the interconnect between the cells; and
heating the assembly such that said particles sinter and form a bond between the interconnect and said anode and between the interconnect and said cathode.
